(19) United States
(12) Patent Application Publication
(10) Pub. No.: US 2023/0049241 A1
(43) Pub. Date: Feb. 16, 2023

(54) Carbon Negative Data Centers and Services

(71) Applicant: Niall Davidson, West Kelowna (CA)

(72) Inventor: Niall Davidson, West Kelowna (CA)

(21) Appl. No.: 17/790,709

(22) PCT Filed: Feb. 5, 2021
(86) PCT No.: PCT/CA2021/050134

§ 371 Date: Jul. 1, 2022

Related U.S. Application Data
(60) Provisional application No. 62/977,380, filed on Feb. 16, 2020.

(51) Int. Cl. B01D 53/62

(52) U.S. Cl. CPC B01D 53/62; B01D 2258/06; B01D 2257/504

(57) ABSTRACT

Captured data center waste-heat is used as the input energy for carbon capture plant. Energy in the form of waste-heat is first captured from servers and other apparatus within the data center and optionally directed as the input to a heat-pump before being directed to the input of carbon capture plant, enabling carbon capture using a data centers waste-heat. Also disclosed are systems and apparatus for data center operators or cloud services to offer carbon negative or carbon neutral services to their customers. Cloud customers are offered options to select a carbon negative or carbon neutral service, the cloud operator storing their choice and then operating or managing carbon capture services to meet their requests.

### BACKGROUND

Climate change and recognition of the part that Carbon Dioxide plays in its cause has become of global concern. With the International Panel on Climate Change sounding the alarm and making it clear that carbon removal technologies will be required as part of any solution.

Carbon capture technologies are being developed by companies such as the United States based Global Thermostat, Canada based Carbon Engineering and Switzerland based Climeworks. Each of these solutions however has not yet found profitability without requiring carbon tax credits.

### SUMMARY

The profitable removal of Carbon Dioxide from the atmosphere is therefore critical to solving climate change.

The present disclosure describes a means to remove carbon dioxide from the atmosphere using a data centers waste-heat and methods to monetize that carbon dioxide removal capability, generating a profit from carbon removal.

### DRAWINGS

These and other features, aspects, and advantages of the present invention will become better understood with regard to the following description, appended claims, and accompanying drawings where:

FIG. 1a shows a method to enable a data centers waste-heat to be used for carbon capture;

FIG. 1b illustrates an example of a data center with carbon capture;

FIGS. 2a and 2b provide an overview of a method for offering a cloud customer a carbon negative service and subsequently provisioning a cloud customers services on data center hardware whose energy is being used for carbon capture;

FIG. 3 shows a mockup of a possible web portal or cloud console with a carbon negative option;

FIGS. 4a and 4b provide an overview of a method for offering a cloud customer a carbon negative service without requiring the cloud customers services to operate on hardware whose waste-heat is being harnessed for carbon capture;

FIGS. 5a and 5b provides an overview of a method for offering a cloud customer a carbon negative service to remove a defined amount of CO2 from the atmosphere, and;

FIG. 6 shows a mockup of a possible web portal of cloud console with a carbon negative option that also collects data on a defined amount of CO2 to be collected.

### DESCRIPTION

It is intended that the following description and claims should be interpreted in accordance with Webster's Third New International Dictionary, Unabridged unless otherwise indicated.

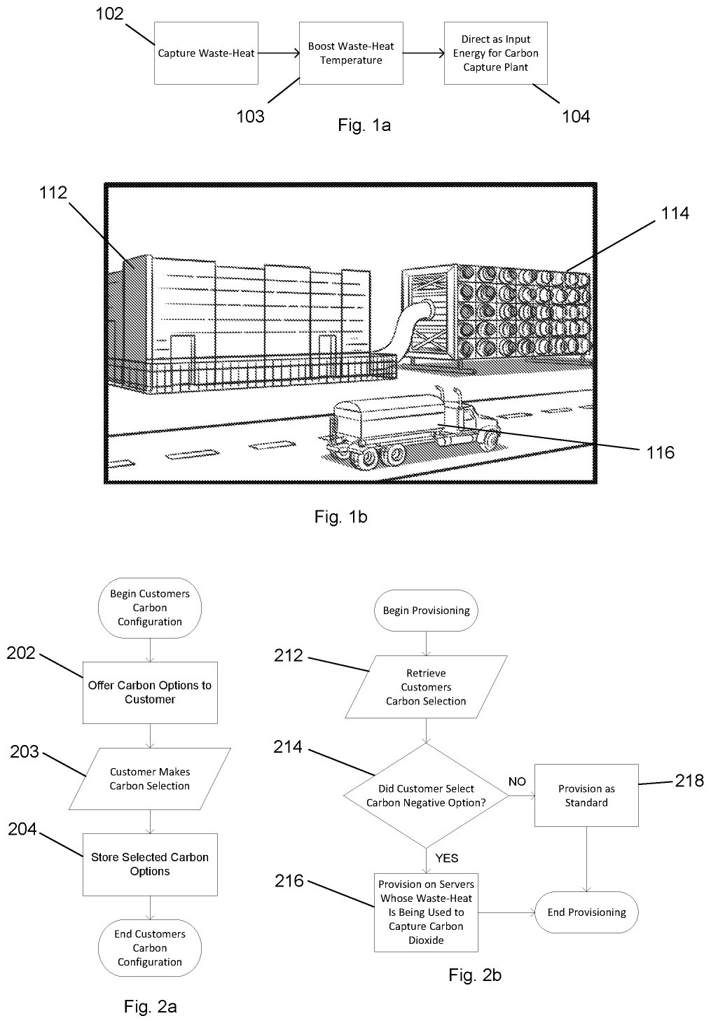

Referring now to FIG. 1a, described is a method and apparatus to enable a data centers waste-heat to be used for carbon capture, the method comprising three steps. Capturing a data centers waste-heat 102, boosting the captured waste-heat in temperature 103 and directing the boosted waste-heat to be used as the input energy for carbon capture plant 104. Once captured, the carbon dioxide can then be sequestered for permanent storage and disposal or sold for use in other processes.

An example of such a data center is shown in FIG. 1b, which shows a data center 112 connected to direct air capture plant 114 with a vehicle 116 removing captured carbon dioxide and taking it to another location.

At present carbon capture technologies available from companies such as the the United States based Global Thermostat and Switzerland based Climeworks require the input of energy in a liquid form at a temperature of approximately 95° C. to 100° C. The present disclosure therefore describes capturing waste-heat in a liquid form, however it is not intended that the present invention be limited to capturing the waste-heat in a liquid form and is intended to also include capturing waste-heat in a gaseous form, boosting the captured waste-heat in temperature and directing the boosted waste-heat as the input energy required for carbon capture plant. Furthermore, as carbon capture technologies are developed it is hoped that the temperature of the required input energy will decrease further, and the present disclosure, while targeting a boosted temperature of approximately 95° C. to 100° C., is applicable to those lower temperatures and to temperatures higher than 100° C.

Capturing a data centers waste-heat can be achieved by the use of several available technologies, including but not being limited to: air-cooling servers within the data center and subsequently using a heat exchange apparatus to transfer heat from the hot air into a liquid form; use of direct liquid cooling technologies such as those available from Denmark based Asetek or Canada based CoolIT, which directly capture a servers waste-heat into a liquid form; use of an immersion cooling apparatus such as those available from the United States based Green Revolution Cooling or Hong Kong based Allied Control, which directly capture a servers waste-heat into a liquid form; use of a rail based cooling technology such as has been developed by the present inventor and disclosed previously, which directly captures a servers waste-heat into a liquid form but with greater cost-efficiency and higher reliability than contemporary cooling technologies, or; any other means existing or yet to be invented that captures waste-heat into a liquid form.

Each of the technologies described in the previous paragraph produce captured waste-heat at a temperature over 20° C., in some cases over 30° C., in other cases over 40° C. and in yet further cases at temperatures as high as 60° C. or 70° C. Typically, however the captured waste-heat produced will be below 100° C. and below the temperature required for the carbon capture plant. In order for the captured waste-heat to be used as the input energy for the carbon capture plant it therefore needs to be boosted in temperature.

Boosting the captured waste-heat in temperature to the approximate 95° C. to 100° C. temperature can be achieved by the use of commonly available technologies such as electrical, gas or other fuel powered boilers or heaters. A more efficient means of boosting the captured waste-heat is to use heat-pumps and either a single heat-pump or multiple heat-pumps can be configured in series to boost the captured waste-heat to the necessary approximately 95° C. to 100° C. temperature efficiently. The use of heat-pumps has the benefit of being able to use a renewable power source such as solar or wind and can cost-effectively boost the captured waste-heat to the necessary temperature.

By capturing the waste-heat from a data center and boosting it in the manner described the cost of the input energy to carbon capture apparatus can therefore be significantly reduced. Depending on the available source and cost of energy, in some cases cutting the energy cost in half or more. Furthermore, by using the waste-heat from a data center less energy infrastructure is required, reducing the load on renewables and other sources of power.

Once captured and boosted the waste-heat is now at the correct temperature and form to be used as the input energy for carbon capture using plant similar to that being manufactured by companies such as Climeworks and Global Thermostat among others. Directing the boosted waste-heat as the input energy for carbon capture plant provides the carbon capture plant with the necessary input energy to be able to capture carbon. The plant and systems necessary to achieve this are readily available to persons having skill in the arts of plant engineering, process engineering and hydronics.

At the present time the cost of operating carbon capture plant exceeds the sale price of carbon dioxide, making the profitable removal of carbon dioxide from the atmosphere via carbon capture difficult if not impossible.

Today's cloud operators, including but not being limited to Amazon Web Services, Microsoft and Google, operate multiple data centers geographically distributed all over the world. In addition they install and operate hardware in co-location facilities managed by 3^{rd} parties. By installing and operating the carbon removal apparatus described above these cloud operators and other data center operators will have the capability to operate as carbon negative facilities.

We describe herein a method for data center and cloud operators to offer carbon negative services or carbon neutral services to their cloud customers, providing a means for generating a profit from carbon removal. Hereafter “cloud customers” is defined to include cloud customers, data center customers and others who consume cloud or data center services including entities who operate their own data centers, examples of such including but not being limited to governments and corporations. Further “cloud operators” are hereafter defined to include data center, co-location and other operators of data center and cloud type services.

For the purposes of this specification, unless otherwise specified, carbon negative is also defined to include carbon neutral, carbon reduced, carbon reduction or other similar terms which refer to the reduction, removal or offsetting of carbon dioxide or its equivalents from the atmosphere. Carbon neutral in the context of this specification refers to determining the carbon footprint of provided services and removing an equivalent amount of carbon dioxide from the atmosphere.

Cloud customers are under pressure to reduce their carbon footprint, however not all cloud customers will want to pay a premium for carbon negative data center or cloud services. There is then an opportunity to offer cloud customers a service whereby they can be certified by the cloud operator as operating carbon neutral or carbon negative, with the revenues generated by those customers being used to operate carbon removal apparatus. Those customers can then benefit by advertising to their clients that they are carbon neutral or carbon negative and may also be able to advertise how much carbon dioxide has been removed from the atmosphere on their behalf.

In one embodiment the cloud operator offers cloud customers a carbon negative service by provisioning purchased services on hardware whose waste-heat is being directly captured and used for carbon capture. FIGS. 2a and 2b provide an overview of the steps followed to configure a cloud customers carbon negative service and subsequently provision the cloud customers services.

By offering such a service the cloud operator can offer both carbon negative and standard services, possibly hosted in the same data center. The cloud operator can then optionally certify to those carbon negative cloud customers that the energy being consumed to operate the services is being used to capture carbon dioxide and may also report the amount of carbon dioxide being captured on their behalf.

Referring to FIGS. 2a and 2b, this can be achieved by: offering a carbon negative option to the cloud customer 202; storing the cloud customers selection 204, and, when provisioning the cloud customers services; retrieving the cloud customers carbon selection 212; determining if the cloud customer selected the carbon negative option 214, and if so; provisioning the cloud customers services on servers whose waste-heat is being used to capture carbon dioxide 216.

The cloud operator may also charge the cloud customer a fee to pay for the costs of operating the carbon capture apparatus, the fee may be calculated based upon the percentage of the available carbon capture plant capacity that the waste-heat produced by the cloud customers services use consumes, or the fee may be calculated based upon a fixed amount per unit of carbon removed or another calculation.

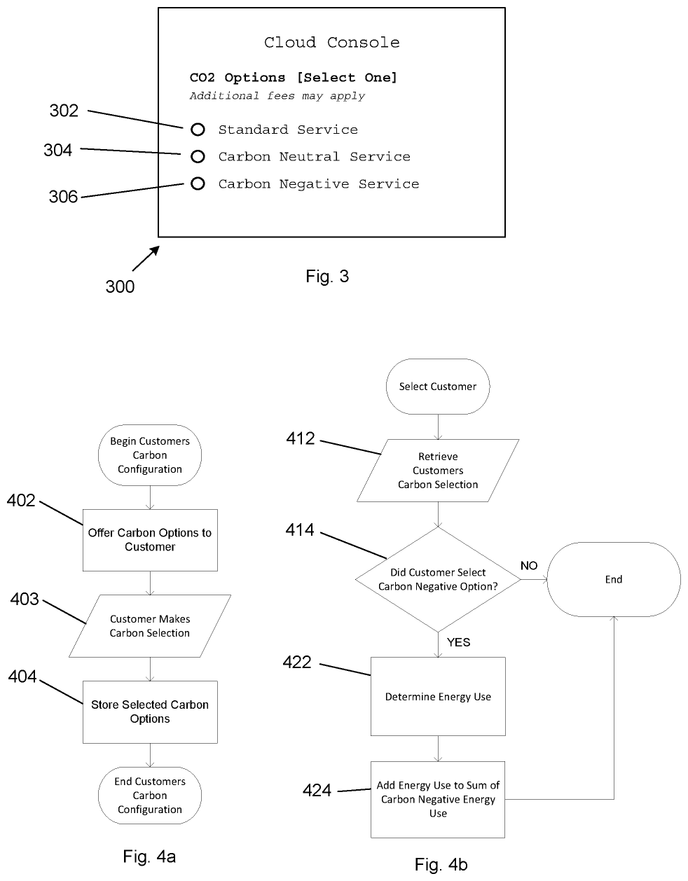

When configuring the cloud customers services the cloud operator offers a carbon negative option 202 to the cloud customer, offering the carbon negative option 202 may comprise: a selectable option on a web portal, cloud console or similar; via a customer service agent, or; other means such as an AI assistant. FIG. 3 shows a mockup 300 of a possible web portal or cloud console with a carbon negative option 304, 306. Mockup 300 shows only one possible configuration, layout and language for a carbon negative option 304, 306 and it is not intended to limit said option to such configuration, layout and language. The carbon negative option 304, 306 may be offered for all of the cloud customers purchased services or may be offered on a per service or per set of services basis or any combination thereof.

Offering a carbon negative option to the cloud customer may also comprise: offering a specific instance type that is specified to be carbon negative, for example a cloud operator may offer a Carbon Neutral or Carbon Negative instance alongside such instances as General Purpose, Compute Optimized, Memory Optimized or other types; offering specific types of carbon negative instances within a category such as General Purpose or Compute Optimized; offering an instance hosted in a zone or data center that is enabled for carbon negative operation, or; as a feature that can be enabled as an add-on as part of a set or range of possible features that a particular service offers.

Once the cloud customer makes their selection 203 from the offered carbon negative option 202 the selection is stored 204 such that it is made available to the provisioning means by which the cloud operator provisions services.

When provisioning the cloud customers services the cloud operators provisioning means, which may comprise of a software management system or one or more individuals, retrieves the cloud customers selection 212 and determines 214 if the carbon negative option was selected. If the carbon negative option was selected the provisioning means provisions the appropriate cloud customers services on a server whose waste-heat is being captured and used for carbon capture 216, otherwise the provisioning means provisions the cloud customers services as standard 218.

Subsequently the cloud operator may optionally provide an approximation as to how much carbon dioxide is being captured on behalf of the cloud customer, this can be achieved by: summing the energy consumed by the cloud customers services over a time period; collecting data on the total waste-heat consumed by the carbon capture plant; dividing the energy consumed by the cloud customers services (numerator) and the total waste-heat consumed (denominator) by the carbon capture plant to produce a captured ratio; determining the carbon dioxide captured over the time period, and multiplying the carbon dioxide captured by the captured ratio to produce an approximation of the carbon dioxide captured using the waste-heat generated by the services being operated on the cloud customers behalf, and; reporting to the cloud customer the approximation of the carbon dioxide captured by the services being operated on its behalf.

$$CO 2 Captured by Cloud Customer = \frac{\sum Energy Consumed by Cloud Customer}{\sum Waste Heat Consumed by Carbon Capture} * Totol CO 2 Captured$$

Accuracy will be improved by optionally determining a loss coefficient that represents how much waste-heat is collected versus how much waste-heat is lost to the environment, that coefficient can be determined by determining the total input energy to all systems whose waste-heat is being collected and determining the total waste-heat input to the carbon capture apparatus. The loss coefficient is determined by dividing the waste-heat input to the carbon capture apparatus by the total input energy to all systems. That loss coefficient can then be used to modify the equation above producing the form below, resulting in a more accurate representation.

$$Loss Coeff = \frac{\sum Waste Heat Consumed by Corbon Capture}{\sum Total Input Energy} CO 2 Captured by Cloud Customer = \frac{\sum Energy Consumed by Cloud Customer * Loss Coeff}{\sum Waste Heat Consumed by Carbon Capture} * Totol CO 2 Captured$$

Summing the energy consumed by the cloud customers services over a time period can be achieved in a variety of means and the cloud operator will already collect some, if not all, of the necessary information for billing purposes. Determining an approximation of the energy consumed by an offered service is dependent on the service, how it is delivered and the various hardware involved. While determining the energy used for a service is beyond the scope of this document a couple of non-exhaustive examples follow.

For example, for services that are billed transactionally the energy consumed by the cloud customers transactions can be determined by dividing the total number of transactions delivered during the time period by the sum of the total energy use of the systems delivering the transactional service during the time period and then multiplying it by the number of transactions billed to the cloud customer.

$$Energy for Transactions = \frac{Total Number of Transactions}{Total Energy Consumed by Transaction Hardware} * Number of Cloud Customers Transactions$$

As another example, for services that are billed based upon processor time the energy consumed by the cloud customer can be determined by dividing the total processor time delivered during the time period on the system upon which the cloud customers service is running divided by the total energy consumed by the system and then multiplying it by the processor time consumed by the cloud customer.

$$Energy for Processor Time = \frac{Total Processor Time}{Total Energy Consumed by System} * Cloud Customers Processor Time$$

Modern cloud operators operate a large number of services, making it a challenge to place some or all of a cloud customers services on servers whose waste-heat is being used for carbon capture. Further, it may be more efficient to offer carbon capture capability in only certain geographic locations, such as locations where carbon capture tax credits are available. As cloud services are not geographically constrained cloud operators will benefit from being able to offer carbon negative service to any cloud customer in any location and for any service without needing to place the cloud customers services in a specific location or on hardware whose waste-heat is being captured and used for carbon capture. Allowing the cloud operator to offer carbon capture services without requiring that any or all customers of a specific data center select a carbon negative service.

In another embodiment of the present invention the cloud operator offers cloud customers a carbon negative service without requiring that the cloud customers services are provisioned on hardware whose waste-heat is being captured and used for carbon capture or indeed in a data center that is operating carbon capture. FIGS. 4a and 4b provide an overview of the steps followed to configure a cloud customers carbon negative service and allocate the energy used by the cloud customers services to carbon capture.

By offering such a carbon negative service the cloud operator can offer both carbon negative and standard services but does not need to provide carbon capture in every facility or capture the waste-heat from all hardware providing services. The cloud operator can then optionally certify to those carbon negative cloud customers that the equivalent energy being consumed to operate the services is being used to capture carbon dioxide and may also report the amount of carbon dioxide being captured on their cloud customers behalf.

This can be achieved by: offering a carbon negative option to the cloud customer; storing the cloud customers selection; provisioning the cloud customers services; operating carbon capture apparatus; determining the energy used by the cloud customers services, and; allocating the energy used by the cloud customers services against the input energy used for the carbon capture apparatus.

Optionally the cloud operator may also charge the cloud customer a fee to pay for the costs of operating the carbon capture apparatus, the fee may be calculated based upon the percentage of the available carbon capture plant capacity that the equivalent energy consumed by the cloud customers services uses or calculated based upon a fixed amount per unit of carbon removed or any other calculation.

Referring to FIG. 4a, when configuring the cloud customers services the cloud operator offers a carbon negative option 402 to the cloud customer, offering the carbon negative option 402 may comprise: a selectable option on a web portal, cloud console or similar; via a customer service agent, or; other means such as an AI assistant. FIG. 3 shows a mockup 300 of a possible web portal or cloud console with a carbon negative option 304, 306. Mockup 300 shows only one possible configuration, layout and language for a carbon negative option 304, 306 and it is not intended to limit said option to such configuration, layout and language. The carbon negative option 304, 306 may be offered for all of the cloud customers purchased services or may be offered on a per service or per set of services basis or any combination thereof.

Offering a carbon negative option to the cloud customer may also comprise: offering a specific instance type that is specified to be carbon negative, for example a cloud operator may offer a Carbon Neutral or Carbon Negative instance alongside such instances as General Purpose, Compute Optimized, Memory Optimized or other types; offering specific types of carbon negative instances within a category such as General Purpose or Compute Optimized; offering an instance hosted in a zone or data center specified as carbon negative, or; as a feature that can be enabled as an add-on as part of a set or range of possible features that a particular service offers.

Once the cloud customer makes their selection 403 from the offered carbon negative option 402 the selection is stored 404 in such a way that it is made available to the cloud operator. The cloud customers services are provisioned as normal.

The cloud operator may operate carbon capture apparatus: in the same data center using some, none, or all of the waste-heat from that data center; in a different data center using some, none or all of the waste-heat from that different data center; by contracting operation to a 3^{rd} party, or; a combination of the preceding. The input energy to the carbon capture apparatus may comprise of waste-heat from the data center, a combination of waste-heat and virgin energy (that is energy that was generated specifically as input energy to carbon capture apparatus), or virgin energy.

After a period of time, such as a standard billing period, the cloud operator may then estimate the approximate amount of energy used by the cloud customer and allocate the energy used by the cloud customers services against the input energy used for the carbon capture apparatus. By doing this for each cloud customer the cloud operator can determine if more, less or an equivalent amount of energy was used for carbon capture than was requested to be used for carbon capture by its cloud customers. This information can then be subsequently used to bill the cloud customer and for future planning.

Referring now to FIG. 4b. To achieve this, for each cloud customer the cloud operator retrieves the cloud customers selection 412 and determines 414 if the carbon negative option was selected. If the carbon negative option was selected then the cloud operator proceeds to determine the cloud customers energy use 422 for services with the carbon negative option selected within the given time period, one possible method of doing this is described above. Once the cloud customers energy use has been determined the cloud operator can then add 424 the cloud customers energy use to the sum of energy used by a set of customers who selected a carbon negative option within the given time period.

Other embodiments may instead add a portion, or some predetermined ratio of the cloud customers energy to the sum of energy used. This may allow the cloud operator to better match emissions or energy costs if the data center hosting the carbon capture apparatus has different costs or a different carbon footprint.

If the total energy consumed by cloud customers who selected a carbon negative service is larger than the total energy input to the carbon capture apparatus then the cloud operator may choose to refund or notify cloud customers as to the over-allocation or may offer the service on a best-effort or auction type of service to manage demand.

Subsequently the cloud operator may optionally provide an approximation as to how much carbon dioxide is being captured on behalf of the cloud customer, this can be achieved by the same method as described above.

In another embodiment the cloud operator offers cloud customers a carbon negative service that offers to remove an amount of CO2 per unit of time or until a total amount has been removed. By offering such a carbon negative service the cloud operator can offer carbon negative services to cloud customers independent of the energy used by any services purchased from the cloud operator. The cloud operator can then optionally certify to those carbon negative cloud customers the amount of carbon dioxide captured on their behalf.

This can be achieved by: offering a carbon negative option to the cloud customer; storing the cloud customers requested carbon capture amount; operating carbon capture apparatus, and; allocating the carbon capture amount requested by the cloud customer against the carbon captured by the carbon capture apparatus.

Optionally the cloud operator may also charge the cloud customer a fee to pay for the costs of operating the carbon capture apparatus, the fee may be calculated based upon the percentage of the available carbon capture plant capacity consumed or the fee may be calculated based upon a fixed amount per unit of carbon removed or any other calculation.

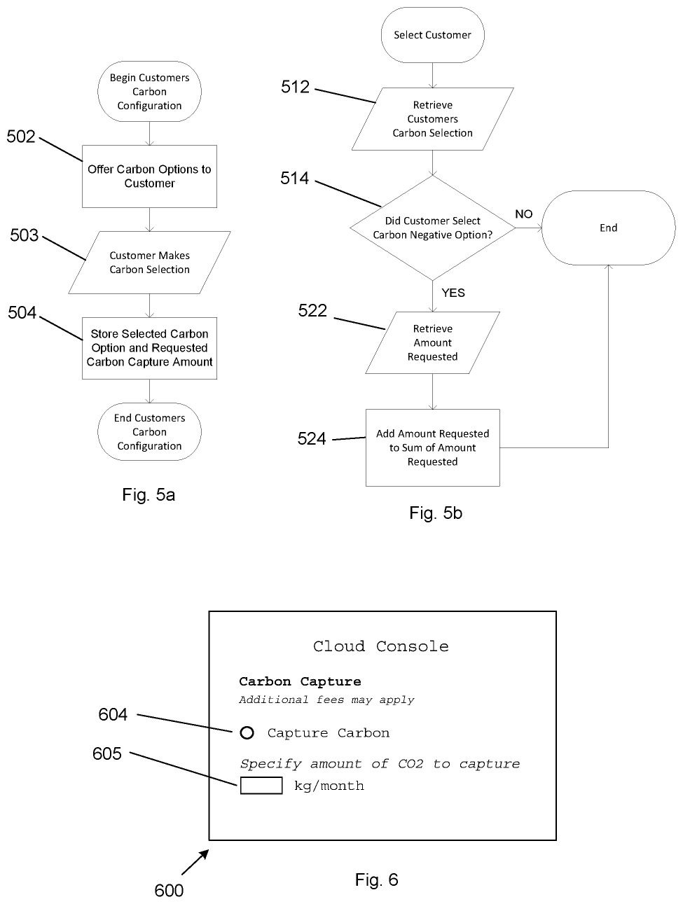

Referring to FIG. 5a, when configuring the cloud customers services the cloud operator offers a carbon negative option 502 to the cloud customer, offering the carbon negative option 502 may comprise: a selectable option on a web portal, cloud console or similar; via a customer service agent, or; other means such as an AI assistant. FIG. 6 shows a mockup 600 of a possible web portal or cloud console with a carbon negative option 604 and a box 605 to enter the requested carbon capture amount. Mockup 600 shows only one possible configuration, layout and language and it is not intended to limit said option to such configuration, layout and language.

Once the cloud customer makes their selection 503 from the offered carbon negative option 502 the selection is stored 504 in such a way that it is made available to the cloud operator. The cloud customers services, if any, are provisioned as normal.

The cloud operator may operate carbon capture apparatus: in the same data center using some, none, or all of the waste-heat from that data center; in a different data center using some, none or all of the waste-heat from that different data center; by contracting operation to a 3^{rd} party, or; a combination of the preceding. The input energy to the carbon capture apparatus may comprise of waste-heat from the data center, a combination of waste-heat and virgin energy (that is energy that was generated specifically as input energy to carbon capture apparatus), or virgin energy.

After a period of time, such as a standard billing period, the cloud operator may then allocate the carbon capture amount requested by the cloud customer against the carbon captured by the carbon capture apparatus. By doing this for each cloud customer the cloud operator can determine if more, less or an equivalent amount of carbon was captured than was requested by its cloud customers. This information can then be subsequently used to bill the cloud customer and for future planning.

Referring now to FIG. 5b. For each cloud customer the cloud operator retrieves the cloud customers selection 512 and determines 514 if the carbon negative option was selected. If the carbon negative option was selected then the cloud operator retrieves the carbon capture amount requested 522 within the given time period and adds 524 the cloud customers amount requested to the sum of the amount requested by a set of customers who selected a carbon negative option within the given time period.

If the total carbon capture amount requested by cloud customers who selected a carbon negative service is larger than the total carbon captured by the carbon capture apparatus then the cloud operator may choose to refund or notify cloud customers as to the over-allocation or may offer the service on a best-effort or auction type of service to manage demand.

Subsequently the cloud operator may optionally provide an approximation as to how much carbon dioxide is being captured on behalf of the cloud customer, this can be achieved by the same method as described above.

In another embodiment of the present invention the cloud operator offers cloud customers a carbon neutral service that offers removal of the amount of CO2 per unit of time that purchased services are estimated to consume. By offering such a carbon neutral service the cloud operator can offer carbon neutral services to cloud customers without requiring the capture of CO2 beyond their usage. The cloud operator can then optionally certify to those carbon neutral cloud customers the amount of carbon dioxide being captured on their behalf.

This can be achieved by: offering a carbon neutral option to the cloud customer; storing the cloud customers selection, provisioning the cloud customers services; determining the energy used by the cloud customers services over a time period; calculating the carbon footprint of the energy used by the cloud customers services over a time period; optionally calculating the carbon footprint of the manufacturing and transportation of hardware used to provide the cloud customers service, and; operating carbon capture apparatus until an amount of CO2 equivalent to the calculated carbon footprint has been captured.

Optionally the cloud operator may also charge the cloud customer a fee to pay for the costs of operating the carbon capture apparatus, the fee may be calculated based upon the percentage of the available carbon capture plant capacity used to offset the calculated carbon footprint, alternatively the fee may be calculated based upon a fixed amount per unit of carbon removed, capacity used or any other calculation.

Although specific embodiments of the invention have been shown and described herein, it is to be understood that these embodiments are merely illustrative of the many possible specific arrangements that can be devised in application of the principles of the invention. Numerous and varied other arrangements can be devised by those of ordinary skill in the art without departing from the scope and spirit of the invention.

What I claim is:

1. A data center configured to remove carbon dioxide from the atmosphere.

2. The data center of claim 1 wherein being configured to remove carbon dioxide from the atmosphere comprises:
a) capturing the data centers waste-heat;
b) boosting the captured waste-heat in temperature, and;
c) directing the boosted waste-heat to be used as input energy for carbon capture plant.

3. The data center of claim 2 wherein the step of capturing the data centers waste-heat comprises capturing waste-heat at a temperature of below around 100° C.

4. The data center of claim 2 wherein the step of capturing the data centers waste-heat comprises capturing waste-heat at a temperature of between about 20° C. and 70° C.

5. The data center of claim 2 wherein the step of boosting the captured waste-heat in temperature comprises directing the captured waste-heat to a heat-pump.

6. The data center of claim 2 wherein capturing the data centers waste-heat comprises capturing waste-heat in a liquid form.

7. The data center of claim 2 wherein capturing the data centers waste-heat comprises air-cooling servers within the data center.

8. The data center of claim 1, the data center comprising:
a) a cooling system that captures waste-heat, and;
b) a carbon capture apparatus, the captured waste-heat being directed into the carbon capture apparatus.

9. The data center of claim 8 further comprising a heat-pump, with the waste-heat captured by the cooling system being first directed into the heat-pump before being directed into the carbon capture apparatus.

10. A carbon negative cloud service, the carbon negative cloud service comprising:
a) a cloud operator offering a carbon negative option to a cloud customer, and
b) the cloud operator operating carbon capture apparatus.

11. The carbon negative cloud service of claim 10 wherein the cloud operator is a data center operator and the cloud customer is a data center customer.

12. The carbon negative cloud service of claim 10 wherein the cloud operator is a cloud service provider.

13. The carbon negative cloud service of claim 10 wherein operating carbon capture apparatus comprises provisioning the cloud customers services on servers whose waste-heat is being used to capture carbon dioxide.

14. The carbon negative cloud service of claim 10 wherein operating carbon capture apparatus comprises provisioning the cloud customers services on servers within a first data center and operating carbon capture apparatus using waste-heat from a second data center.

15. The carbon negative cloud service of claim 10 wherein operating carbon capture apparatus comprises contracting carbon capture operation to a 3^{rd} party.

16. The carbon negative cloud service of claim 10 wherein operating carbon capture apparatus comprises contracting carbon offsetting to a 3^{rd} party.

17. (canceled)

18. The carbon negative cloud service of claim 10 wherein the offering a carbon negative option to a cloud customer comprises offering to remove an amount of carbon dioxide.

19-23. (canceled)

24. A computer-implemented method that includes the step of:
a) offering a carbon negative option to a cloud customer;

25. The computer-implemented method of claim 24 further comprising the steps of:
b) provisioning the cloud customers services on a server whose waste-heat is being used for carbon capture.

26. The computer-implemented method of claim 24 further comprising the steps of:
b) estimating the approximate energy used by the cloud customer, and;
c) allocating the energy used by the cloud customer against the input energy for operating carbon capture apparatus.
